(19) United States
(12) Patent Application Publication
(10) Pub. No.: US 2005/0143487 A1
(43) Pub. Date: Jun. 30, 2005

(54) Aqueous flexographic printing inks

(76) Inventors: Anjing Lou, New York, NY (US); John Krech, Airmont, NY (US); Richard R. Durand, Woodridge, NJ (US); Michelle Webb, Upper Marlboro, MD (US)

Correspondence Address: Sun Chemical Corporation, 222 Bridge Plaza South, Fort Lee, NJ, 07024, US

(21) Appl. No.: 10/751,163

(22) Filed: Dec. 31, 2003

(51) Int. Cl. C03C 17/00; C09D 11/00

(52) U.S. Cl. 523/160; 523/161

(57) ABSTRACT

An aqueous flexographic printing ink composition containing a pigment, a styrene:acrylic copolymer and a plasticizer.

### FIELD OF THE INVENTION

The invention relates to aqueous flexographic printing inks that produce high gloss when printed using high speed on a rough surface.

### BACKGROUND OF THE INVENTION

The demands for high speed quality printing have created conditions not favorable to the production of high gloss. Printing on a rough substrate is particularly difficult for achieving high gloss since gloss depends on the degree of smoothness of the print surface. It is known that final gloss of printed ink can be generated by coating the paper substrate, but the cost of coated newsprint or other rough paper substrates would be prohibitive from use.

As stated above, print gloss is conventionally produced either by printing the ink on coated smooth paper, as presented in U.S. Pat. No. 4,012,543, or applying heat set press, as described in U.S. Pat. No. 3,405,082 for lithographic printing. Radiation curing is another method for achieving high gloss, as reported in U.S. Pat. Nos. 4,204,010, 4,334,970 and 5,554,212. Patent EP 0771861 A3 describes a phase change ink, which may generate high gloss by controlling the temperature to over the thermo-inversion point of the hyperthermogelling component for the jet ink.

Japanese Patent JP 62-179504 discloses the use of the styrene/acrylic copolymer as a binder in inks to generate good film gloss and durability for corrugated fibreboard.

Therefore, there is a need for a high speed flexographic quality printing ink that produces high gloss, particularly on a rough surface.

### SUMMARY OF THE INVENTION

The present invention provides an aqueous flexographic printing ink composition comprising a pigment, a styrene:acrylic copolymer and a plasticizer.

The present invention also provides a method of improving print gloss of an aqueous flexographic printing ink composition comprising adding to said printing ink prior to printing a styrene:acrylic copolymer and a plasticizer.

Other objects and advantages of the present invention will become apparent from the following description and appended claims.

### DETAILED DESCRIPTION OF THE INVENTION

In accordance with the present invention, it has been surprisingly discovered that gloss on conventional rough surface newsprint with aqueous flexographic printing inks can be generated during high speed printing by introducing a styrene/acrylic copolymer and a plasticizer to printing ink formulas.

Suitable styrene:acrylic copolymers include, but are not limited to those having a pH of above 7.5. It is preferred that the styrene:acrylic copolymer is Lucidene 612 manufactured by Roman Haas of Springhouse, Pa. The styrene:acrylic copolymer is about 40-80 wt. % of the composition, preferably about 50-70 wt. %.

The aqueous flexographic printing ink also include a plasticizer, which may be sorbitol or n-propyl lactate. The plasticizer functions to soften the surface of the polymer particles and bridge them to form a uniform network structure. The plasticizer is about 3-20 wt. % of the composition, preferably about 5-20 wt. %, and more preferably about 8-12 wt. % The aqueous flexographic printing ink further contains pigment. Suitable pigments include but are not limited to monoazo yellows, monoarylide yellows, diarylide yellows, naphthol reds, rubine reds, lithol rubines, phtalocyanine blues, and carbon black. Other suitable pigments include but are not limited to Pigment Yellow 1, Pigment Yellow 3, Pigment Yellow 11, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 127, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 57:1, Pigment Red 112, Pigment Red 170, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment violet 23, and Pigment Black 7.

The aqueous flexographic printing ink of the present invention also contains water. Other additives may be included such as defoamers. Any rheological additive may also be added as appropriate and include those known in the art.

The aqueous flexographic printing inks of the present invention are formulated by adding a plasticizer, such as sorbitol or n-propyl lactate, to a copolymer, such as a styrene:acrylic copolymer. The pigment may be added at any time. Water and additives such as a defoamer may also be added at any time to the aqueous flexographic printing ink composition.

Aqueous flexographic printing inks prepared according to the present invention are suitable for coated or uncoated paper substrates, with the advantage of the invention being the gloss value of the printing ink on an uncoated substrate. Aqueous flexographic printing inks of the present invention were run at room temperature on a Genik press at 1200 fpm on newsprint (uncoated paper substrate). The print results for all the experimental aqueous flexographic printing inks showed high gloss above the paper ranging from 1.5 to 3 points, as measured on a 750 micro-gloss meter. Comparison conventional flexographic printing inks typically have gloss values from 1.5 to 3.5 points below the paper.

In addition, print densities and first impression set-offs of the printing inks of the present invention were equal or comparable to the conventional printing inks. All the printing inks were also run on a Chesnut press at 300 fpm for color trap tests. The color trap gloss results for the printing inks of the present invention had gloss values further increased beyond the simple sum for single color printing. Further, density and set-off of the inks of the present invention are comparable to comparison conventional aqueous flexographic printing inks which generate gloss below the paper.

The aqueous flexographic printing ink compositions of the present invention are further illustrated by the following non-limiting examples in which all parts and percentages of components are by weight and based on the total weight of the composition, unless otherwise indicated.

### EXAMPLE 1

A water based flexographic black printing ink was prepared as set forth in Table 1 below.

TABLE 1

| Components | Wt % |
|---|---|
| Styrene:acrylic copolymer | 63.0 |
| (Lucidene 612) | |
| Pigment (carbon black | 20.0 |
| dispersion, T9068-G, | |
| manufactured by ABCO | |
| Enterprises of Allegan, MI) | |
| Water | 9.55 |
| Plasticizer (sorbitol, 70% Soln.) | 7.2 |
| Defoamer (65 Additive, | 0.25 |
| manufactured by Dow Corning of | |
| Midland, MI) | |
| TOTAL | 100.0 |

The experimental aqueous flexographic printing ink was run twice on a Genik press at 1200 fpm for three minutes at room temperature on Bowater 30 lb newsprint, at line ruling 500 and then line ruling 440. No difference was observed in terms of gloss, density or set-off for either run.

The newsprint of the experimental aqueous flexographic printing ink run on a 500 line ruling was the tested for gloss and density compared to a conventional aqueous flexographic printing ink. The test for gloss was measured with a 750 Micro-Gloss Meter manufactured by BYK Gardener of Columbia, Md. The test for density was measured on an X-Rite 428, manufactured by X-Rite Corp. of Grandville, Mich. The test results are set forth in Table 2 below.

TABLE 2

| Ink | Gloss | Density |
|---|---|---|
| Example 1 Ink | 1.8 | 1.01 |
| Comparative | −1.8 | 0.99 |
| conventional ink | | |

The aqueous flexographic printing ink of Example 1 produced a much higher gloss than the conventional aqueous flexographic printing ink, while maintaining comparable density to the conventional aqueous flexographic printing ink. In addition, the first impression set-off of the aqueous flexographic printing ink of Example 1 was comparable to the conventional aqueous flexographic printing ink.

### EXAMPLE 2

A water based flexographic yellow printing ink was prepared as set forth in Table 3 below.

TABLE 3

| Components | Wt % |
|---|---|
| Styrene:acrylic copolymer | 63.0 |
| (Lucidene 612) | |
| Pigment (yellow pigment | 20.0 |
| dispersion, YCD-9113, | |
| manufactured by Sun | |
| Chemical, of Ft. Lee, NJ) | |
| Plasticizer (sorbitol, 70% | 7.2 |
| Soln.) | |
| Water | 9.55 |
| Defoamer (65 Additive, | 0.25 |
| manufactured by Dow | |
| Corning of Midland, MI) | |
| TOTAL | 100.0 |

The experimental aqueous flexographic printing ink of Example 2 was run twice on a Genik press as set froth in Example 1 above. No difference was observed in terms of gloss, density or set-off for either run. The newsprint of the experimental aqueous flexographic printing ink run on a 500 line ruling was the tested for gloss (750 Micro-Gloss Meter) and density (X-Rite 428) compared to a conventional aqueous flexographic printing ink as described in Example 1. The test results are set forth in Table 4 below.

TABLE 4

| Ink | Gloss | Density |
|---|---|---|
| Example 2 Ink | 2.9 | 0.79 |
| Comparative | −2.4 | 0.81 |
| conventional | | |
| ink | | |

The aqueous flexographic printing ink of Example 2 produced a much higher gloss than the conventional aqueous flexographic printing ink, while maintaining comparable density to the conventional aqueous flexographic printing ink. In addition, the first impression set-off of the aqueous flexographic printing ink of Example 2 was comparable to the conventional aqueous flexographic printing ink.

### EXAMPLE 3

A water based flexographic magenta printing ink was prepared as set forth in Table 5 below. Based upon a color-match consideration, a colorant was introduced to Example 3.

TABLE 5

| Components | Wt % |
|---|---|
| Styrene:acrylic copolymer | 59.69 |
| (Lucidene 612) | |
| Pigment (magenta pigment | 10.28 |
| dispersion, RCD-9928, | |
| manufactured by Sun Chemical | |
| Corporation of Ft. Lee, NJ) | |
| Water | 11.18 |
| Plasticizer (sorbitol, 70% Soln.) | 10.0 |
| Colorant (Liquidtone Magenta | 8.35 |
| 418, manufactured by Milliken | |
| Chemical of Spartanburg, SC) | |
| Defoamer (70% Foamex 825 and | 0.5 |
| 30% Foamex 3062, manufactured | |
| by Tego, Chemie Service GmbH | |
| of Essen, DE) | |
| TOTAL | 100.0 |

The experimental aqueous flexographic printing ink of Example 3 was run twice on a Genik press as set froth in Example 1 above. No difference was observed in terms of gloss, density or set-off for either run. The newsprint of the experimental aqueous flexographic printing ink run on a 500 line ruling was the tested for gloss (750 Micro-Gloss Meter) and density (X-Rite 428) compared to a conventional aqueous flexographic printing ink as described in Example 1. The test results are set forth in Table 6 below.

TABLE 6

| Ink | Gloss | Density |
|---|---|---|
| Example 3 | 2.4 | 0.88 |
| Ink | | |
| Comparative | 0.5 | 0.98 |
| conventional | | |
| ink | | |

The aqueous flexographic printing ink of Example 3 produced a much higher gloss than the conventional aqueous flexographic printing ink, while maintaining comparable density to the conventional aqueous flexographic printing ink. In addition, the first impression set-off of the aqueous flexographic printing ink of Example 3 was comparable to the conventional aqueous flexographic printing ink.

### EXAMPLE 4

A water based flexographic cyan printing ink was prepared as set forth in Table 7 below.

TABLE 7

| Components | Wt % |
|---|---|
| Styrene:acrylic copolymer | 63 |
| (Lucidene 612) | |
| Pigment (cyan pigment | 18 |
| dispersion, BCD-9444, | |
| manufactured by Sun | |
| Chemical, of Ft. Lee, NJ) | |
| Plasticizer (sorbitol, 70% | 14 |
| solution) | |
| Water | 4.5 |
| Defoamer (70% Foamex 825 | 0.5 |
| and 30% Foamex 3062, | |
| manufactured by Tego | |
| Chemie Service GmbH of | |
| Essen, DE) | |
| TOTAL | 100.0 |

The experimental aqueous flexographic printing ink of Example 4 was run twice on a Genik press as set froth in Example 1 above. No difference was observed in terms of gloss, density or set-off for either run. The newsprint of the experimental aqueous flexographic printing ink run on a 500 line ruling was the tested for gloss (750 Micro-Gloss Meter) and density (X-Rite 428) compared to a conventional aqueous flexographic printing ink as described in Example 1. The test results are set forth in Table 8 below.

TABLE 8

| Ink | Gloss | Density |
|---|---|---|
| Example 3 Ink | 2.8 | 1.02 |
| Comparative | −1.7 | 0.87 |
| conventional ink | | |

The aqueous flexographic printing ink of Example 4 produced a much higher gloss than the conventional aqueous flexographic printing ink, while maintaining comparable density to the conventional aqueous flexographic printing ink. In addition, the first impression set-off of the aqueous flexographic printing ink of Example 4 was comparable to the conventional aqueous flexographic printing ink.

### EXAMPLE 5

Color traps using the experimental aqueous flexographic printing inks from Examples 2, 3, and 4, were tested on a Chesnut press at 300 fpm and compared with color traps run on the same press using conventional aqueous flexographic printing inks. The Gloss Value was measured with a 750 Micro-Gloss Meter. The results are set forth in Table 9 below.

TABLE 9

| | Gloss |
|---|---|
| Inks | Value |
| Yellow (Example 2 Ink) trapped over | 6.5 |
| magenta (Example 3 Ink) | |
| Comparison conventional yellow ink | −1.0 |
| trapped over magenta | |
| Yellow (Example 2 Ink) trapped over | 5.8 |
| cyan (Example 4 Ink) | |
| Comparison conventional yellow ink | −0.6 |
| trapped over cyan | |
| Cyan (Example 4 Ink) trapped over | 5.2 |
| magenta (Example 3 Ink) | |
| Comparison conventional cyan ink | 1.7 |
| trapped over magenta | |

### EXAMPLE 6

A water based flexographic black printing ink was prepared as set forth in Table 1 below.

TABLE 10

| Components | Wt % |
|---|---|
| Styrene:acrylic copolymer | 66.0 |
| (Lucidene 612) | |
| Pigment (cyan pigment | 18.0 |
| dispersion, BCD-9444, | |
| manufactured by Sun Chemical, | |
| of Ft. Lee, NJ) | |
| Water | 11.5 |
| Plasticizer (n-propyl lactate, | 4 |
| manufactured by PURAC | |
| America, Inc, Lincolnshire, IL) | |
| Defoamer (70% Foamex 825 | 0.5 |
| and 30% Foamex 3062, | |
| manufactured by Tego Chemie | |
| Service GmbH of Essen, DE) | |
| TOTAL | 100.0 |

The experimental aqueous flexographic printing ink of Example 4 was run twice on a Genik press as set froth in Example 1 above. No difference was observed in terms of gloss, density or set-off for either run. The newsprint of the experimental aqueous flexographic printing ink run on a 500 line ruling was the tested for gloss (750 Micro-Gloss Meter) and density (X-Rite 428) compared to a conventional aqueous flexographic printing ink as described in Example 1. The test results are set forth in Table 11 below.

TABLE 11

| Ink | Gloss | Density |
|---|---|---|
| Example 6 Ink | 3.8 | 1.02 |
| Comparative | −1.7 | 0.87 |
| conventional ink | | |

The invention has been described in terms of preferred embodiments thereof, but is more broadly applicable as will be understood by those skilled in the art. The scope of the invention is only limited by the following claims.

1. An aqueous flexographic printing ink composition comprising a pigment, a styrene:acrylic copolymer, and a plasticizer.

2. The ink composition of claim 1, wherein said pigment is selected from the group consisting of monoazo yellow, monoarylide yellow, diarylide yellow, naphthol red, rubine red, lithol rubine, phtalocyanine blue, and carbon black.

3. The ink composition of claim 2, wherein said pigment is selected from the group consisting of Pigment Yellow 1, Pigment Yellow 3, Pigment Yellow 11, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 127, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 57:1, Pigment Red 112, Pigment Red 170, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment violet 23, and Pigment Black 7.

3. The ink composition of claim 1, wherein said styrene:acrylic copolymer is about 40 to 80 wt. % of the composition.

4. The ink composition of claim 3, wherein said styrene:acrylic copolymer is about 50 to 70 wt. % of the composition.

5. The ink composition of claim 1, wherein said plasticizer is sorbitol.

6. The ink composition of claim 1, wherein said plasticizer is n-propyl lactate.

7. The ink composition of claim 1, wherein said plasticizer is about 3 to 20 wt. % of the composition.

8. The ink composition of claim 7, wherein said plasticizer is about 8 to 12 wt. % of the composition.

9. The ink composition of claim 8, wherein said plasticizer about 10 wt. % of the composition.

10. A method of improving print gloss of an aqueous flexographic ink composition comprising adding to said ink prior to printing a styrene:acrylic copolymer and a plasticizer.

11. The method of claim 10, wherein said styrene:acrylic copolymer is added in an amount equal to about 40 to 80 wt. % of the total weight of the composition.

12. The method of claim 11, wherein said styrene:acrylic copolymer is added in an amount equal to about 50 to 70 wt. % of the total weight of the composition.

13. The method of claim 10, wherein said plasticizer is sorbitol.

14. The method of claim 10, wherein said plasticizer is n-propyl lactate.

15. The method of claim 10, wherein said plasticizer is added in an amount equal to about 3 to 20 wt. % of the composition.

16. The method of claim 15, wherein said plasticizer is present in an amount equal to about 8 to 12 wt. % of the composition.

17. The method of claim 16, wherein said plasticizer is added in an amount equal to about 10 wt. % of the composition.

18. The method of claim 10, wherein said improvement in print gloss is achieved when printing on a rough surface.
